(19) United States
(12) Patent Application Publication
(10) Pub. No.: US 2016/0065676 A1
(43) Pub. Date: Mar. 3, 2016

(54) Control Of Network Connected Systems

(71) Applicant: Raytheon BBN Technologies, Corp., Cambridge, MA (US)

(72) Inventor: John-Francis Mergen, Baltimore, MD (US)

(73) Assignee: Raytheon BBN Technologies, Corp.

(21) Appl. No.: 14/474,376

(22) Filed: Sep. 2, 2014

(51) Int. Cl. H04L 29/08; H04W 74/00; H04L 29/12

(52) U.S. Cl. CPC H04L 67/125; H04L 61/2557; H04W 74/002; H04W 84/12

(57) ABSTRACT

Technology for controlling network connected systems is disclosed. A wireless network can be scanned in order to determine a list of active network addresses. The list of active network addresses can be associated with a plurality of wireless devices that are actively communicating within the wireless network. One or more active network addresses of interest can be identified from the list of active network addresses. An address profile associated with the active network addresses of interest can be identified. One or more network connected systems can be controlled according to a predefined set of rules in the address profile.

### BACKGROUND

The use of mobile devices has grown rapidly in recent years. Users may carry numerous types of mobile devices, such as mobile phones, tablet computers, e-book readers, or laptops. The mobile devices may allow the users to easily perform a variety of tasks, such as respond to electronic messages, check the weather, read about current events, look up scores for a sporting event, etc. In one example, the users may perform the tasks after connecting to a local network that offers an available network and/or increased network speeds. The users may connect to the local network when, for example, the users arrive at home, an office building, a restaurant, a stadium, etc.

### BRIEF DESCRIPTION OF THE DRAWINGS

Features and advantages of the disclosure will be apparent from the detailed description which follows, taken in conjunction with the accompanying drawings, which together illustrate, by way of example, features of the disclosure; and, wherein:

FIG. 1 illustrates a system for detecting a presence of an active network address of interest and controlling one or more network connected systems according to a predefined set of rules in an address profile when the active network address of interest is present in accordance with an example;

FIG. 2 illustrates a system for detecting an absence of an active network address of interest and controlling one or more network connected systems according to a predefined set of rules in a default profile when the active network address of interest is absent in accordance with an example;

FIG. 3 illustrates a system for detecting a presence or absence of active network addresses of interest and controlling network connected systems based on the presence or absence of the active network addresses of interest in accordance with an example;

FIG. 4 depicts a flow chart of a method for controlling network connected systems in accordance with an example;

FIG. 5 depicts a flow chart of another method for controlling network connected systems in accordance with an example; and

FIG. 6 is a system for controlling network connected systems in accordance with an example.

Reference will now be made to the exemplary embodiments illustrated, and specific language will be used herein to describe the same. It will nevertheless be understood that no limitation of the scope of the invention is thereby intended.

### DETAILED DESCRIPTION

Before the present invention is disclosed and described, it is to be understood that this invention is not limited to the particular structures, process steps, or materials disclosed herein, but is extended to equivalents thereof as would be recognized by those ordinarily skilled in the relevant arts. It should also be understood that terminology employed herein is used for the purpose of describing particular examples only and is not intended to be limiting. The same reference numerals in different drawings represent the same element. Numbers provided in flow charts and processes are provided for clarity in illustrating steps and operations and do not necessarily indicate a particular order or sequence.

### Example Embodiments

An initial overview of technology embodiments is provided below and then specific technology embodiments are described in further detail later. This initial summary is intended to aid readers in understanding the technology more quickly but is not intended to identify key features or essential features of the technology nor is it intended to limit the scope of the claimed subject matter.

Technology is described for detecting a presence or absence of network addresses and controlling a network connected system based on the presence or absence of the network addresses. The network addresses can be associated with a plurality of devices, such as mobile phones, desktop computers, printers, laptops, smart refrigerators, and others as recognized by those skilled in the art. A network address is present when the network address is active on a network (e.g., a local wireless network). In other words, the device associated with the active network address can be actively communicating within the network. The network address is absent when the device, with its associated network address, is not active on the network. A network address of interest can be identified from the network addresses that are active on the network. In one example, the network address of interest can be associated with an address profile. The address profile can include a predefined set of rules that are to be implemented by network connected systems when the network address of interest is active on the network. The network connected systems can include, but are not limited to, heating, ventilation and air-conditioning (HVAC) systems, alarm systems, lighting systems, greeting systems, audio/visual systems, and others as recognized by those skilled in the art.

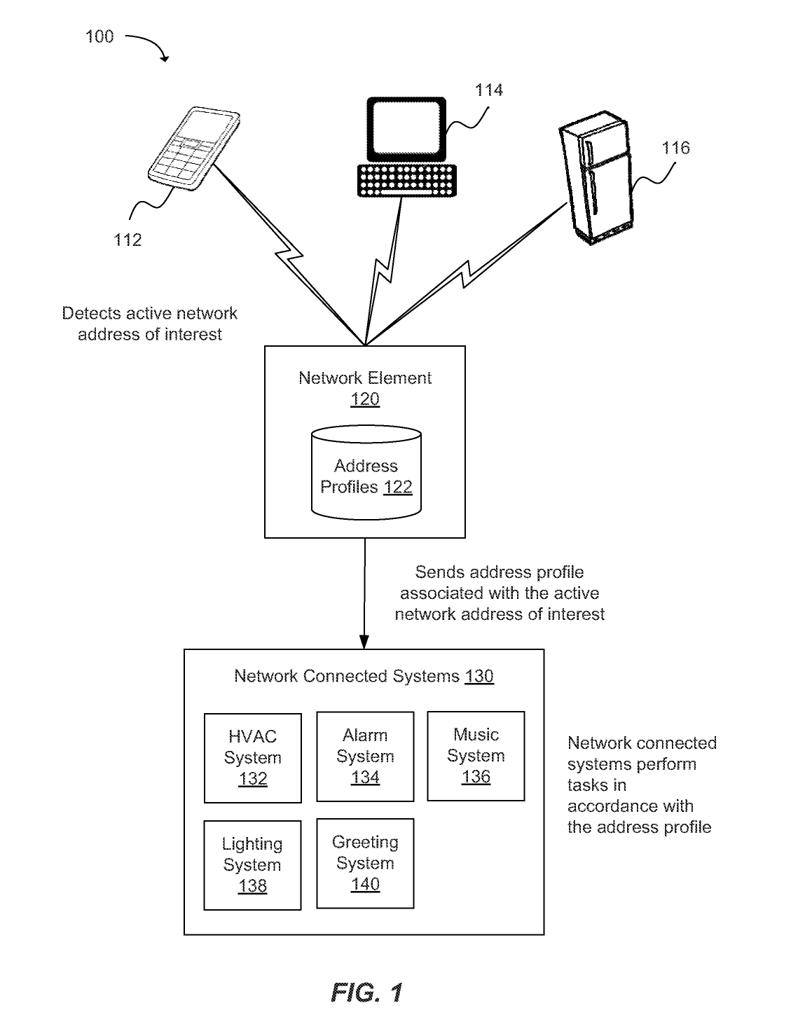

FIG. 1 illustrates a system 100 for controlling network connected systems 130 based on an active network address of interest being present on a network. A network element 120 (e.g., a wireless network element) can identify network addresses that are active on the network. The network element 120 can scan the network in order to identify the network addresses that are active. The network addresses that are active on the network can be associated with electronic devices that are actively communicating within the network. For example, the network element 120 can detect network addresses that are associated with a mobile phone 112, a desktop computer 114 and a smart refrigerator 116 if the network addresses are actively communicating within the network. In one example configuration, the network element 120 can use an address resolution protocol (ARP) in order to detect the network addresses that are active on the network.

The network element 120 may be unable to detect network addresses that are inactive on the network. For example, a desktop computer that has transitioned into a sleep mode in order to conserve power can be associated with an inactive network address because the desktop computer is not actively communicating within the network. In other words, the network address associated with the desktop computer can be absent from the network, and therefore, the network element 120 may be unable to identify the network address. As another example, a desktop computer, mobile phone, laptop, etc. that is turned off is not actively communicating within the network, and therefore, the network addresses associated with these may not be detected.

In one example, the network addresses can be active on a wireless local area network (WLAN). The WLAN can link two more devices using a wireless distribution technique, such as spread-spectrum or orthogonal frequency-division multiplexing (OFDM). The WLAN can provide users a connection through an access point to the Internet. The WLAN can allow users the ability to move within a local coverage area and remain connected to the local wireless network. WLANs are based on Institute of Electrical and Electronics Engineers (IEEE) 802.11 standards and are commonly referred to as Wi-Fi.

Alternatively, the network addresses can be active on a wireless personal area network (WPAN), such as a Bluetooth personal area network (PAN). Bluetooth is a wireless technology standard for exchanging data over short distances (using short-wavelength UHF radio waves in the ISM band from 2.4 to 2.485 GHz) from fixed and mobile devices.

The network element 120 can maintain a list of active network addresses. In other words, when a device connects to the WLAN, the network address associated with the device can be added to the list of active network addresses. When the device disconnects from the WLAN or exits the coverage area of the WLAN, the network address associated with the device can be removed from the list of active network addresses. In addition, a network address can be removed from the list when the network address becomes inactive (e.g., the device associated with the network address is turned off or goes into sleep mode).

In one example, the network address can be a unique identifier associated with a particular device. Each device (e.g., computer, phone, and printer) can be assigned a unique identifier. One example of a unique identifier is a media access control (MAC) address. The MAC address can be assigned by a manufacturer of the network interface controller (NIC) in the device. The MAC address can be stored in the device's hardware, such as in a read-only memory.

The presence or absence of active network addresses can generally indicate whether particular users are present or absent within a coverage area of a local wireless network. The coverage area can be a user's home, apartment, place of business, etc. Alternatively, the coverage area can be a warehouse, auditorium, office building, or other public areas with access to the local wireless network. For example, a user carrying a mobile phone can arrive at home, which is within the coverage area of the local wireless network. The mobile phone can be preprogrammed to automatically connect to the local wireless network when the mobile phone is within the coverage area. The network element 120 can detect that the network address associated with the mobile phone is active on the local wireless network. Therefore, the user associated with the mobile phone can be inferred to be within the coverage area. As another example, the user may leave home and carry their mobile phone with them. Therefore, the network address associated with the mobile device becomes inactive on the local wireless network and the user can be inferred as not being at home. In yet another example, a network address associated with a desktop computer can be detected as being active on the local wireless network, and therefore, one or more users that generally use the desktop computer can be inferred as being present within the coverage area of the local wireless network.

Inactive network addresses associated with sleeping devices may not be included on the list of active network addresses. However, the device can be present within the coverage area of the local network (albeit sleeping), but the network element 120 can falsely infer that the device and the user associated with the device are not currently present within the coverage area of the local network. Thus, in one example, the network element 120 can apply a hysteresis to delay setting by a predetermined duration a particular network address as being absent or inactive. For example, the network element 120 can wait the predetermined duration (e.g., 10 minutes) before determining that the particular network address is inactive. In other words, the network element 120 may not detect the particular network address as being active, but can be caused to wait the predetermined duration before setting the particular network address as inactive. The predetermined duration of delay can be configured to be of any desired or required length. As a result, the network element 120 may reduce false negatives. In one example, a false negative can be a determination that a device is absent in the coverage area when the device is in fact present in the coverage area.

In one configuration, the network element 120 can identify network addresses of interest from the list of network addresses that are active on the network. The network addresses of interest may be preselected by one or more users. For example, a user may previously select the network addresses associated with the user's mobile phone and tablet computer, respectively, as network addresses of interest. In many cases, a network address of interest will be one that is associated with a device, which device can be associated with a particular user and their preferences. The network addresses of interest can be compiled onto a predefined list of network addresses of interest. In addition, the user may exclude certain network addresses from the predefined list of network addresses of interest. In one example, network addresses that generally correspond to particular users (e.g., a network address associated with a user's mobile phone) can be included on the predefined list of network addresses of interest, whereas network addresses that correspond to devices that are generally left on or not associated with particular users (e.g., smart refrigerators, thermostats, routers, access points, set-top boxes, printers and servers) can be excluded from the predefined list of network addresses of interest. In other words, these network addresses, even if active on the network, can be filtered from the predefined list of network addresses of interest.

The network element 120 can compare the list of active network addresses (e.g., network addresses associated with the mobile phone 112, the desktop computer 114 and the smart refrigerator 116) with the predefined list of network addresses of interest. The network element 120 can identify an active network address of interest based on a comparison of the list of active network addresses and the predefined list of network addresses of interest. In other words, the active network address of interest may be included on both the list of active network addresses and the predefined list of network addresses of interest.

As a non-limiting example, the network element 120 can identify the list of active network addresses including the network addresses associated with the mobile phone 112, the desktop computer 114, and the smart refrigerator 116. The predefined list of network addresses of interest can be generated to include the network address associated with the mobile phone 112, but the network addresses of the desktop computer 114 and the smart refrigerator 116 can be excluded from the predefined list. Therefore, when the network element 120 compares the list of active network addresses with the predefined list of network addresses of interest, the network element 120 can identify the network address associated with the mobile phone 112 as being an active network address of interest.

The network element 120 can further comprise a plurality of stored address profiles 122. The network element 120 can identify an address profile 122 associated with an active network address of interest or a range of active network addresses of interest. The network element 120 can identify the address profile 122 associated with a specific network address of interest from a plurality of address profiles 122 that are stored in the network element 120. The address profile 122 can include a predefined set of rules that are to be implemented by one or more of the network connected systems 130 when the network element 120 detects the active network address of interest. In some examples, the address profile 122 can include rules related to a task or function to be performed, such as raising an indoor temperature, controlling lights, providing a greeting, playing music, etc. when the active network address of interest is detected by the network element 120.

The network element 120 can generate a message with instructions based on the address profile 120. The network element 120 can send the message with the instructions to the network connected systems 130. The network connected systems 130 can include devices or systems that are connected to the network. In one example, the network connected systems 130 can include, but are not limited to, a HVAC system 132, an alarm system 134, a music system 136, a lighting system 138 and a greeting system 140. The network connected systems 130 can receive the message from the network element 120 and perform a task in accordance with the instructions in the message.

As a non-limiting example, the network element 120 can detect an active network address of interest, wherein the active network address of interest is associated with a smart watch worn by User A. The network element 120 can detect the active network address of interest when User A arrives at home. The network element 120 can identify the address profile 122 associated with the active network address of interest. The address profile 122 can include rules to adjust a temperature in the home to 70° F. and start playing jazz music in the home. Based on the address profile 122, the network element 120 can send instructions to the HVAC system 132 to adjust the temperature to 70° F. and send instructions to the music system 136 to start playing jazz music. The HVAC system 132 and the music system 136 may implement the instructions that were received, respectively, from the network element 120. In other words, when User A is wearing the smart watch and arrives at home, the network connected systems 130 can perform tasks related to the address profile 122, and that are set by the User A.

As another non-limiting example, the network element 120 can detect a first active network address of interest and a second active network address of interest. The first active network address of interest can be associated with a smart watch worn by User A and a second active network address of interest can be associated with a mobile phone carried by User B. The network element 120 can identify a first address profile when the first active network address of interest is detected and a second address profile when the second active network address of interest is detected. For example, the first address profile can include rules to adjust the temperature to 70° F. and start playing jazz music for User A. The second address profile can include rules to deactivate an alarm system and turn on kitchen lights for User B. Thus, multiple address profiles can be used when multiple active network addresses of interest are detected.

In addition, an address profile can account for a specific combination of active network addresses of interest. For example, the first address profile related to the active network address of interest associated with User A's device can indicate a temperature setting of 75 degrees F. The second address profile related to the active network address of interest associated with User B's device can indicate a temperature setting of 68 degrees F. However, if both User A and User B and their respective devices are detected to be active within the coverage area of the local wireless network, one or both of the first and second address profiles can comprise a rule for setting the temperature to 72 degrees F. in resolution of the conflict of rules between User A's address profile and User B's address profile. In other words, the first and/or second address profiles can include a rule to set the temperature to 72 degrees F. only when both User A's and User B's devices are active on the local wireless network. As such, one of the rules that can be contained in an address profile is a rule relating to a function or task based upon the detection of one or more other active devices and their associated network addresses.

Alternatively, in the event two or more network addresses of interest are detected, and the associated address profiles of these contain conflicting rules, the network element 120 can select an address profile established for the combination of network addresses of interest, for example, an address profile for the combination of network addresses of interest associated with the devices of User A and User B. In another aspect, the network element 120 can detect a plurality of active network addresses of interest, and cause a function or task to be performed by one or more network connected systems simply based on the number of active network addresses of interest. For example, the network element 120 can instruct a network connected system 130 to increase a blower speed in an auditorium as the number of active network addresses of interest in a local wireless network increase.

In another example, the network element 120 can cause user information associated with a plurality of active network addresses of interest to be conveyed to an annunciator board, so that information on users that enter or exit a building can be displayed. As another example, the network element 120 can provide the user information to a central system in order to aid in head count during a building evacuation.

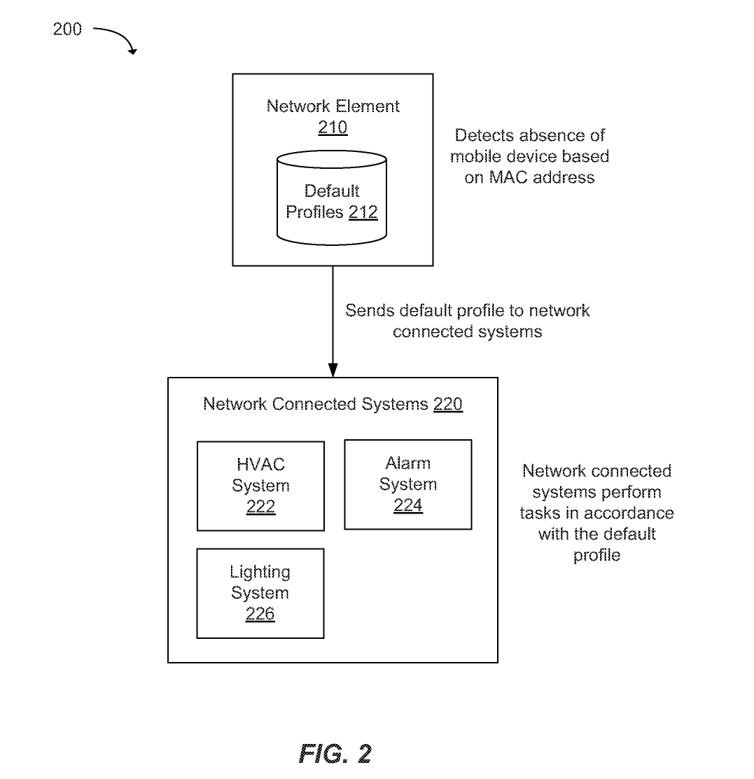

FIG. 2 illustrates a system 200 for controlling network connected systems 220 based on a network address of interest being absent or inactive on a network. A network element 210 (e.g., a wireless network element) can identify that a network address of interest is inactive on the network. The inactive network address of interest can be associated with an electronic device that is not communicating within the network. In other words, the inactive network address of interest can indicate that a user associated with the electronic device is not present in a coverage area of a local wireless network. In one configuration, the network element 210 can use an address resolution protocol (ARP) in order to detect that the network address of interest is inactive on the network.

In one example, the network element 210 can apply a hysteresis to delay setting a particular network address of interest as being absent or inactive by a predetermined duration. For example, the network element 210 can wait the predetermined duration (e.g., 10 minutes) before determining that the particular network address of interest is inactive on the network. In other words, the particular network address of interest can be determined to be inactive after a hysteresis period in order to preclude false negatives associated with sleeping devices.

The network element 210 can have stored therein, and identify one or more default profiles 212. The default profile 212 can be associated with a network address of interest. The default profile 212 can include a predefined set of rules that are to be implemented by network connected systems 220 when the network element 210 detects that the network address of interest is inactive on the network. In some examples, the default profile 212 can include rules related to lowering an indoor temperature, turning off lights, activating an alarm, etc. when the network address of interest is determined to be inactive on the network. In addition, the default profile 212 can include rules to be implemented by network connected systems 220 when substantially no active network addresses of interest are detected on the network. The network element 210 can generate a message with instructions based on the default profile 212. The network element 210 can send the message with the instructions to the network connected systems 220. The network connected systems 220 can include devices or systems that are connected to the network. The network connected systems 220 can include, but are not limited, a HVAC system 222, an alarm system 224, and a lighting system 226. The network connected systems 220 can receive the message from the network element 210 and perform a task in accordance with the instructions in the message. Therefore, the HVAC system 222 can lower an indoor temperature, the alarm system 224 can activate an alarm, and the lighting system 226 can turn off lights in accordance with the predefined set of rules in the default profile 212.

As a non-limiting example, the network element 210 can identify a network address of interest that is inactive on the network. The network address of interest can be associated with a tablet computer used by User A. The network element 210 can identify the default profile 212 associated with the network address of interest. The default profile 212 can include rules to reduce a temperature in User A's office to 65° F. The network element 212 can send instructions to the HVAC system 222 to reduce the temperature and the HVAC system 222 can implement the instructions that were received from the network element 212. In other words, when User A leaves the office, and therefore the network address associated with User A's tablet computer becomes inactive, the network connected systems 220 can perform tasks related to the default profile 212.

As another non-limiting example, the network element 210 can detect substantially no active network address of interest. For example, a plurality of users and their associated devices can be outside a coverage area of a local wireless network. The network element 210 can identify the default profile 212 including rules that are to be implemented by the network connected systems 220 when substantially no active network addresses of interest are detected. The rules can include activating an alarm and reducing a temperature. The network element 212 can send instructions to activate the alarm and reduce the temperature to the network connected systems 220. In other words, when the plurality of users leave the coverage area, the network connected systems 220 can perform tasks related to the default profile 212.

Although some specific examples are discussed herein, essentially, it will be recognized by those skilled in the art that the systems described herein can detect the activity or inactivity of one or more devices being associated with a network addresses and/or network addresses of interest, can comprise one or more profiles (default and/or address profiles) associated with one or more of these devices and addresses, or a combination of these, wherein the profiles can comprise various rules for causing a task or function to be performed (or not performed) by one or more network connected systems, and that the system can be configured to implement any rule or any combination of rules as needed or desired. All of the various possible scenarios or situations are contemplated herein.

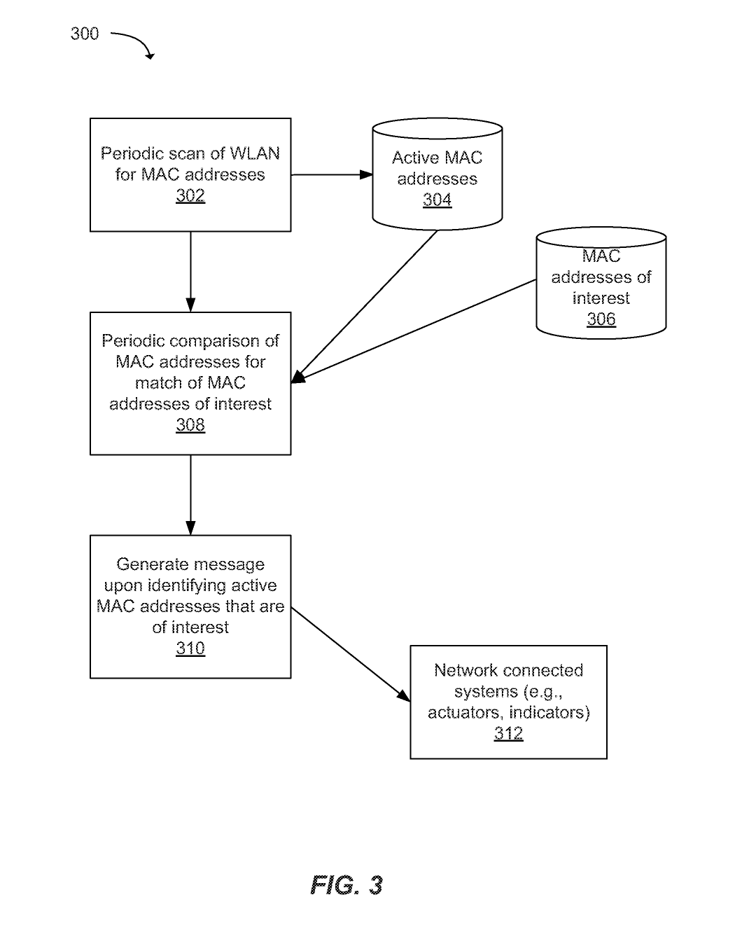

FIG. 3 illustrates an exemplary system 300 and related operations for detecting a presence or absence of active network addresses of interest and controlling network connected systems based on the presence or absence of the active network addresses of interest. In step 302, a periodic scan of a wireless local area network (WLAN) can be performed in order to identify media access control (MAC) addresses that are active on the WLAN. The MAC addresses can be associated with devices that are actively communicating within the WLAN. In one example, the periodic scan of the WLAN can be performed using an address resolution protocol (ARP). In step 304, a list of active MAC addresses can be stored in a first database.

In step 306, a predefined list of MAC addresses of interest can be stored in a second database. The MAC addresses of interest on the list can be preselected by one or more users. For example, a user may select the MAC address associated with the user's mobile phone as being a MAC address of interest. As another example, the user can select the MAC address associated with a smart refrigerator as not being a MAC address of interest.

In step 308, the list of active MAC addresses can be compared with the predefined list of MAC addresses of interest. An active MAC address of interest can be identified based on a comparison of the list of active MAC addresses and the predefined list of MAC addresses of interest. In other words, the active MAC address of interest may be included on both the list of active MAC addresses and the predefined list of MAC addresses of interest. In step 310, a message can be generated upon identifying the active MAC address of interest. The message can include instructions corresponding to the active MAC address of interest. For example, the message can include instructions for playing music over a central audio system, providing a greeting on an annunciator board, etc. In step 312, the message can be sent to one or more network connected systems that include actuators, indicators, controllers, etc. The network connected systems can implement the instructions included in the message.

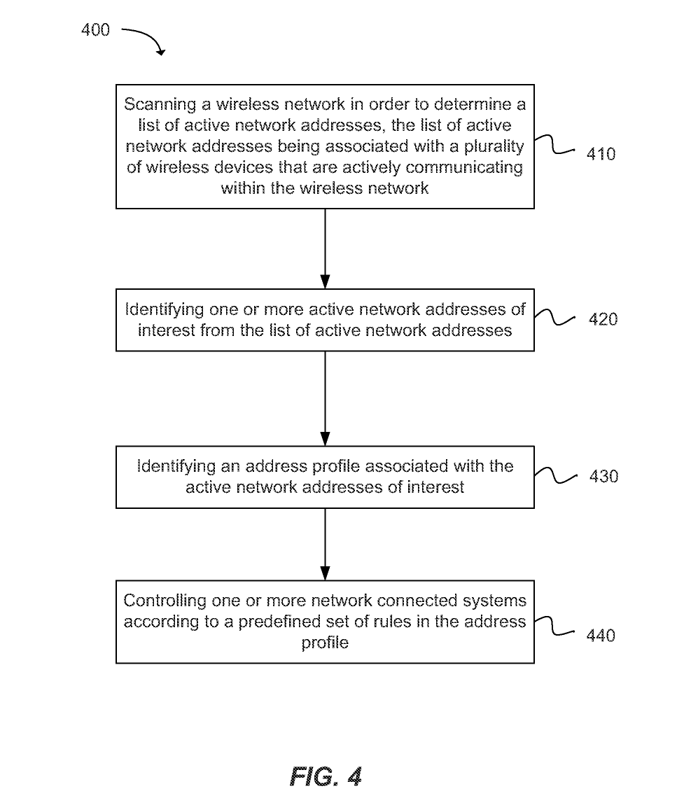

FIG. 4 depicts a flow chart of a method 400 for controlling network connected systems. A wireless network can be scanned in order to determine a list of active network addresses, as in block 410. The list of active network addresses can be associated with a plurality of wireless devices that are actively communicating within the wireless network. In one example, scanning the wireless network further comprises determining one or more media access control (MAC) addresses that are active on a wireless local area network (WLAN). In an example, an address resolution protocol (ARP) can be used to scan the wireless network.

One or more active network addresses of interest can be identified from the list of active network addresses, as in block 420. The list of active network addresses can be compared with a predetermined list of network addresses of interest. The one or more active network addresses of interest can be identified, wherein the active network addresses of interest can be included on both the list of active network addresses and the predetermined list of network addresses of interest. In one example, a hysteresis can be applied when determining the list of active network addresses.

An address profile associated with the active network addresses of interest can be identified, as in block 430. Alternatively, the address profile can be associated with a range of active network addresses of interest. The address profile can include a predefined set of rules that are to be implemented by the network connected systems upon identifying the active network addresses of interest. For example, the address profile associated with a particular cell phone's network address may include rules to increase a room temperature. In other words, when the particular cell phone is active on the wireless network, the rules in the address profile can be implemented.

One or more network connected systems can be controlled according to a predefined set of rules in the address profile, as in block 440. In some examples, controlling the one or more network connected systems can include controlling a heating, ventilation and air conditioning (HVAC) system according to the predefined set of rules in the address profile; controlling a lighting system according to the predefined set of rules in the address profile; controlling an alarm system according to the predefined set of rules in the address profile; providing a greeting to a user associated with the wireless device according to the predefined set of rules in the address profile; and controlling any other controllable component or element within the network connected systems, or controlling a combination of these. In one configuration, no active network addresses of interest can be detected from the list of active network addresses. The one or more network connected systems can be controlled based on this, and according to a default set of rules.

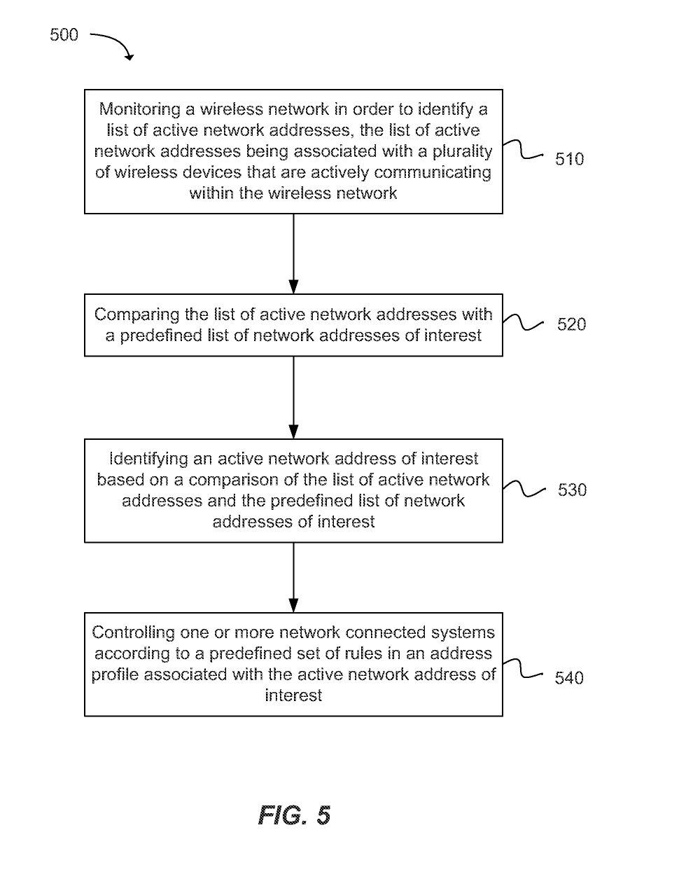

FIG. 5 depicts a flow chart of a method 500 for controlling network connected systems. A wireless network can be monitored in order to identify a list of active network addresses, as in block 510. The list of active network addresses can be associated with a plurality of wireless devices that are actively communicating within the wireless network. In one example, monitoring the wireless network further comprises identifying a list of media access control (MAC) addresses that are active on a wireless local area network (WLAN). In an example, an address resolution protocol (ARP) can be used to monitor the wireless network.

The list of active network addresses can be compared with a predefined list of network addresses of interest, as in block 520. The predefined list of network addresses of interest can include a network address that is associated with a user's device, such as a cell phone. In other words, the cell phone's network address is of interest. In one example, the list of active network addresses may include network addresses associated with a printer and a smart refrigerator. Whether the network addresses associated with the printer and the smart refrigerator are included in the predefined list of network addresses of interest can be determined.

An active network address of interest can be identified based on a comparison of the list of active network addresses and the predefined list of network addresses of interest, as in block 530. As an example, an active network address associated with a user's laptop computer can be of interest when the active network address is included on both the list of active network addresses and the predefined list of network addresses of interest. In one configuration, active network addresses that are not of interest can be filtered based on the comparison of the list of active network addresses and the predefined list of network addresses of interest.

One or more network connected systems can be controlled according to a predefined set of rules in an address profile associated with the active network address of interest, as in block 540. In one configuration, no network addresses of interest can be detected upon monitoring the wireless network, and the one or more network connected systems can be controlled according to a default set of rules.

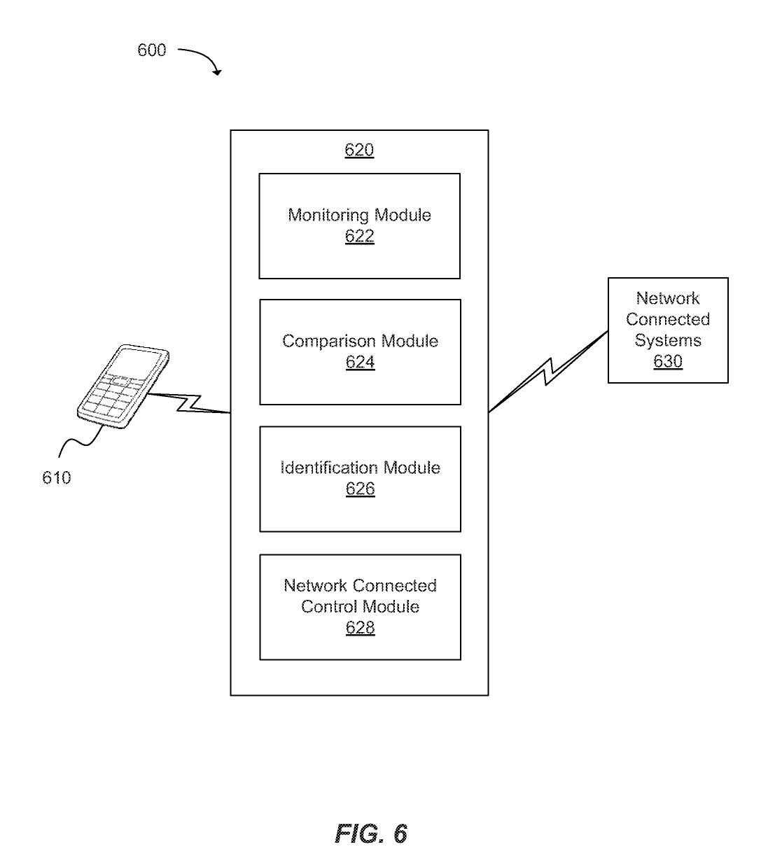

FIG. 6 depicts an exemplary system 600 for controlling network connected systems 630. The system 600 can include a network element 620. The network element 620 can include a monitoring module 622, a comparison module 624, an identification module 626 and a network connected control module 628. The n 620 can communicate with a wireless device 610 and network connected systems 630 over a network. Although not shown, the network element 620 can also comprise a processor and one or more memory devices including a data store to store a plurality of data and instructions.

The monitoring module 622 can be configured to monitor a wireless network in order to identify a list of active network addresses. The list of active network addresses can be associated with a plurality of wireless devices 610 that are actively communicating within the wireless network. The monitoring module 622 can be further configured to monitor the wireless network using an address resolution protocol (ARP). In addition, the monitoring module 622 can be further configured to identify one or more media access control (MAC) addresses that are active on a wireless local area network (WLAN).

The comparison module 624 can be configured to compare the list of active network addresses with a predefined list of network addresses of interest. The predefined list of network addresses of interest can include a network address that is associated with a user's device, such as a cell phone. In other words, the cell phone's network address is of interest. As an example, if the network address associated with the user's cell phone is active, the comparison module 624 may determine whether the cell phone's network address is included in the predefined list of network addresses of interest.

The identification module 626 can be configured to identify an active network address of interest based on a comparison of the list of active network addresses and the predefined list of network addresses of interest. In other words, if a particular network address (e.g., a network address associated with a user's cell phone) is included on both the list of active network addresses and the predefined list of network addresses, then the particular network address is of interest.

The network connected control module 628 can be configured to control one or more network connected systems 630 according to a predefined set of rules in an address profile associated with the active network address of interest. The network connected control module 628 can be further configured to control the one or more network connected systems according to a default set of rules upon detecting substantially no active network addresses of interest. In addition, the network connected control module 628 can be further configured to control a heating, ventilation and air conditioning (HVAC) system according to the predefined set of rules in the address profile, control a lighting system according to the predefined set of rules in the address profile, control an alarm system according to the predefined set of rules in the address profile, or provide a greeting to a user associated with the wireless device according to the predefined set of rules in the address profile.

Various techniques, or certain aspects or portions thereof, may take the form of program code (i.e., instructions) embodied in tangible media, such as floppy diskettes, CD-ROMs, hard drives, non-transitory computer readable storage medium, or any other machine-readable storage medium wherein, when the program code is loaded into and executed by a machine, such as a computer, the machine becomes an apparatus for practicing the various techniques. In the case of program code execution on programmable computers, the computing device may include a processor, a storage medium readable by the processor (including volatile and non-volatile memory and/or storage elements), at least one input device, and at least one output device. The volatile and non-volatile memory and/or storage elements may be a RAM, EPROM, flash drive, optical drive, magnetic hard drive, or other medium for storing electronic data. The satellite may also include a transceiver module, a counter module, a processing module, and/or a clock module or timer module. One or more programs that may implement or utilize the various techniques described herein may use an application programming interface (API), reusable controls, and the like. Such programs may be implemented in a high level procedural or object oriented programming language to communicate with a computer system. However, the program(s) may be implemented in assembly or machine language, if desired. In any case, the language may be a compiled or interpreted language, and combined with hardware implementations.

It should be understood that many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions, which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. The modules may be passive or active, including agents operable to perform desired functions.

Reference throughout this specification to “an example” or “exemplary” means that a particular feature, structure, or characteristic described in connection with the example is included in at least one embodiment of the present invention. Thus, appearances of the phrases “in an example” or the word “exemplary” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as defacto equivalents of one another, but are to be considered as separate and autonomous representations of the present invention.

Furthermore, the described features, structures, or characteristics may be combined in any suitable manner in one or more embodiments. In the following description, numerous specific details are provided, such as examples of layouts, distances, network examples, etc., to provide a thorough understanding of embodiments of the invention. One skilled in the relevant art will recognize, however, that the invention can be practiced without one or more of the specific details, or with other methods, components, layouts, etc. In other instances, well-known structures, materials, or operations are not shown or described in detail to avoid obscuring aspects of the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

What is claimed is:

1. A method for controlling network connected systems, the method comprising:
under control of one or more computer systems configured with executable instructions:
scanning a wireless network in order to determine a list of active network addresses, the list of active network addresses being associated with a plurality of wireless devices that are actively communicating within the wireless network;
identifying one or more active network addresses of interest from the list of active network addresses;
identifying an address profile associated with the active network addresses of interest; and
controlling one or more network connected systems according to a predefined set of rules in the address profile.

2. The method of claim 1, wherein scanning the wireless network further comprises determining one or more media access control (MAC) addresses that are active on a wireless local area network (WLAN).

3. The method of claim 1, further comprising using an address resolution protocol (ARP) to scan the wireless network.

4. The method of claim 1, further comprising:
comparing the list of active network addresses with a predetermined list of network addresses of interest; and
identifying the one or more active network addresses of interest, the active network addresses of interest being included on both the list of active network addresses and the predetermined list of network addresses of interest.

5. The method of claim 1, further comprising:
detecting no active network addresses of interest from the list of active network addresses; and
controlling the one or more network connected systems according to a default set of rules.

6. The method of claim 5, further comprising applying a hysteresis when determining the list of active network addresses.

7. The method of claim 1, wherein controlling the one or more network connected systems includes controlling a heating, ventilation and air conditioning (HVAC) system according to the predefined set of rules in the address profile.

8. The method of claim 1, wherein controlling the one or more network connected systems includes controlling a lighting system according to the predefined set of rules in the address profile.

9. The method of claim 1, wherein controlling the one or more network connected systems includes controlling an alarm system according to the predefined set of rules in the address profile.

10. The method of claim 1, wherein controlling the one or more network connected systems includes providing a greeting to a user associated with the wireless device according to the predefined set of rules in the address profile.

11. A method for controlling network connected systems, the method comprising:
under control of one or more computer systems configured with executable instructions:
monitoring a wireless network in order to identify a list of active network addresses, the list of active network addresses being associated with a plurality of wireless devices that are actively communicating within the wireless network;
comparing the list of active network addresses with a predefined list of network addresses of interest;
identifying an active network address of interest based on a comparison of the list of active network addresses and the predefined list of network addresses of interest; and
controlling one or more network connected systems according to a predefined set of rules in an address profile associated with the active network address of interest.

12. The method of claim 11, wherein monitoring the wireless network further comprises identifying a list of media access control (MAC) addresses that are active on a wireless local area network (WLAN).

13. The method of claim 11, further comprising filtering active network addresses that are not of interest based on the comparison of the list of active network addresses and the predefined list of network addresses of interest.

14. The method of claim 11, further comprising using an address resolution protocol (ARP) to monitor the wireless network.

15. The method of claim 11, further comprising:
detecting no network addresses of interest upon monitoring the wireless network; and
controlling the one or more network connected systems according to a default set of rules.

16. A system for controlling network connected systems, the system comprising:
a processor;
a memory device including a data store to store a plurality of data and instructions that, when executed by the processor, cause the processor to execute:
a monitoring module configured to monitor a wireless network in order to identify a list of active network addresses, the list of active network addresses being associated with a plurality of wireless devices that are actively communicating within the wireless network;
a comparison module configured to compare the list of active network addresses with a predefined list of network addresses of interest;
an identification module configured to identify an active network address of interest based on a comparison of the list of active network addresses and the predefined list of network addresses of interest; and
a network connected control module configured to control one or more network connected systems according to a predefined set of rules in an address profile associated with the active network address of interest.

17. The system of claim 16, wherein the monitoring module is further configured to monitor the wireless network using an address resolution protocol (ARP).

18. The system of claim 16, wherein the monitoring module is further configured to identify one or more media access control (MAC) addresses that are active on a wireless local area network (WLAN).

19. The system of claim 16, wherein the network connected control module is further configured to control the one or more network connected systems according to a default set of rules upon detecting substantially no active network addresses of interest.

20. The system of claim 16, wherein the network connected control module is further configured to:
control a heating, ventilation and air conditioning (HVAC) system according to the predefined set of rules in the address profile;
control a lighting system according to the predefined set of rules in the address profile;
control an alarm system according to the predefined set of rules in the address profile; or
provide a greeting to a user associated with the wireless device according to the predefined set of rules in the address profile.
